(19) United States
(12) Patent Application Publication
(10) Pub. No.: US 2006/0258300 A1
(43) Pub. Date: Nov. 16, 2006

(54) High-frequency wireless signal coupler

(76) Inventors: Yat-To Chan, Pingjhen City (TW); Yu-Ching Tsen, Chungli City (TW)

Correspondence Address: LIN & ASSOCIATES INTELLECTUAL PROPERTY, P.O. BOX 2339, SARATOGA, CA, 95070-0339, US

(21) Appl. No.: 11/130,290

(22) Filed: May 16, 2005

(51) Int. Cl. H04B 1/46

(52) U.S. Cl. 455/82; 333/124

(57) ABSTRACT

Disclosed is a high-frequency wireless signal coupler, in which a plurality of metallic signal lines on two opposite sides of an electronic device is invested with a Teflon body, respectively. The metallic signal lines transmit a high-frequency signal through an impedance of 50 or 75 ohms at a frequency as high as 60 GHz. The coupler is also provided with an outer frame for encaging the Teflon body such that two sides of the electronic device can be securely connected to form the electronic device a unitary body.

### BACKGROUND OF THE INVENTION

1. Field of the Invention

The present invention relates to a signal coupler, and more specifically, to a high-frequency wireless signal coupler.

2. The Prior Arts

The IEEE 802.11x is a series of universal wireless LAN standards erected by IEEE, in which 802.11 is the earliest one used for data-accessing only at a transmission rate below 2 Mbps in early days. As such a speed is too low to satisfy the practical requirements, IEEE has declared later on some versions including 802.11b, 802.11a, and 802.11g, which are to be described below in brief.

The 802.11b is so far the version in most common use and it can transmit data wirelessly online at a rate of 11 Mbps within 300 m outdoors or 100 m indoors, and its speed can be switched according to circumstances among 11 Mbps, 5.5 Mbps, 2 Mbps, and 1 Mbps by means of dynamic speed drifting. The nominal transmission speed of 11 Mbps (practically 550-600 KB/s) provided by 802.11b could be good enough for most broadband subscribers until now though, there are still demands coming for faster transmission service, not to mention the fact that 1 MB/s is already introduced to a number of families. 802.11b looks somewhat exhausted.

As a successor after 802.11b, 802.11a is more advantageous than 802.11b in: (1) better security; more channels (twelve channels) available to have wave interference lessened; (2) 5 times transmission speed, as high as 54 Mbps theoretically, for servicing more subscribers. In addition, because of its peculiar working band at 5 GHz, 802.11a is more excellent in interference resist than 802.11b/g. For example, many electrical home appliances are working at 2.4 GHz, about the same with 802.11b/g, thus, the quality of a subscriber's wireless phone or wireless LAN cannot be maintained constantly due to wave interference.

On the other hand, with its outstanding resistant power against wave interference at 5 GHz working band when compared with 2.4 GHz, 802.11a is proclaimed to vanish in illusion sooner or later, because 5 GHz is particularly weak in transmission distance, reflection, and diffraction that deteriorate the covering range of 802.11a. Besides, the 802.11a products are much more complicated in design to thereby result in a relatively high cost.

Now that both 802.11a and 802.11b cannot satisfy people as desired, IEEE has declared later on the standard specifications of 802.11g, which, same with 802.11b and compared with 802.11a, has adopted 2.4 GHz as the working band under the transmission speed of 54 Mbps, such that the incompatibility problem after upgrade can be solved. Meanwhile, the 802.11g also inherits from 802.11b the merit of low cost vast covering range. When a subscriber is transiting a “g network”, all he/she has to do is purchase an additional AP (access point) of wireless network while the original web card of 802.11b is still valid. Therefore, it can be seen that 802.11g is more flexible in application than 802.11a.

In summary, 802.11g is advantageous in: a speed as high as 802.11a; and a better security than that of 802.11b, and compatible with the latter. Unfortunately, both 802.11g and 802.11b can use only three channels, thus, the security of 802.11g is inferior to 802.11a.

### SUMMARY OF THE INVENTION

The primary object of the present invention is to provide a high-frequency wireless signal coupler, which can provide meanwhile high-frequency transmission couplings of different frequencies or a single frequency by means of investing metallic signal lines of electronic devices on different sides with a Teflon body, in which the metallic signal lines are arranged to provide exclusive couplings for a multi-signal source to a multi-angle directivity antenna or a smart antenna.

Another object of the present invention is to provide a high-frequency wireless signal coupler, which can securely connect electronic devices on opposite sides by means of investing metallic signal lines of electronic devices with Teflon body and encage them with an outer frame.

For more detailed information regarding advantages or features of the present invention, at least one example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIGS. 1A-1C are schematic views of a high-frequency wireless signal coupler of the present invention; and

FIG. 2 is an embodiment schematic view of the present invention.

### DETAILED DESCRIPTION OF THE PREFERRED EMBODIMENT

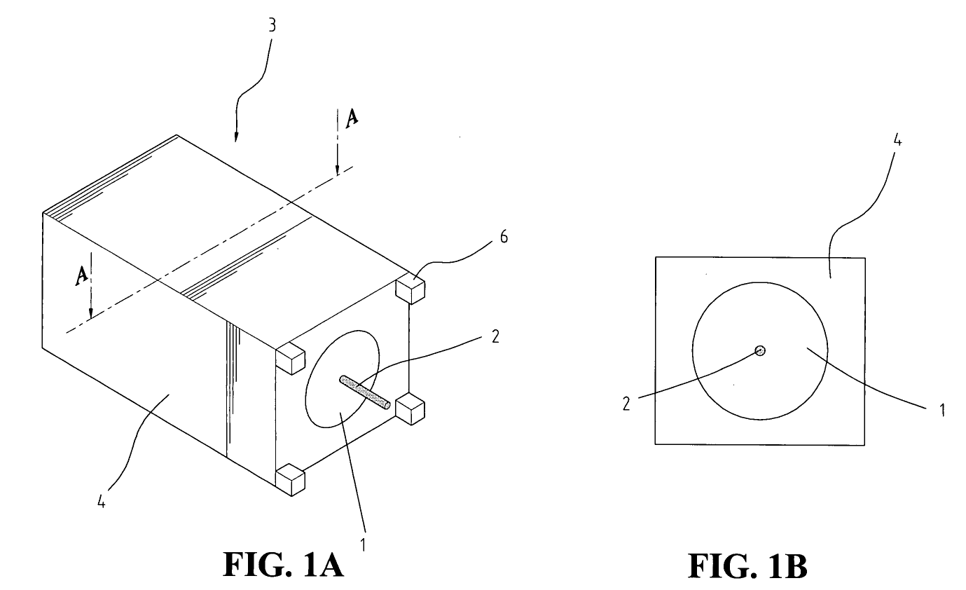

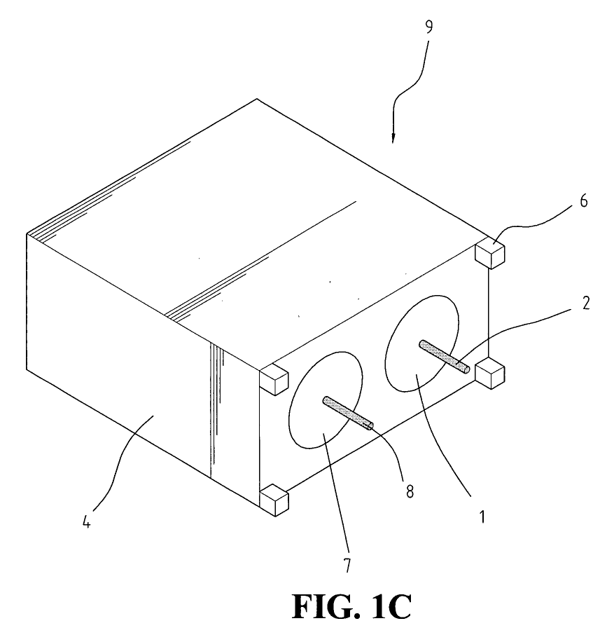

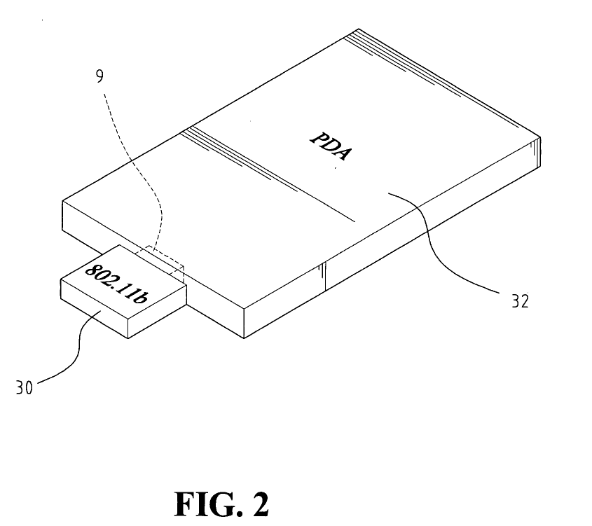

FIGS. 1A-1C are schematic views of a high-frequency wireless signal coupler of the present invention. As shown in FIG. 1A, a high-frequency wireless signal coupler 3 is formed by investing a metallic signal line 2 (usually a copper cord), which penetrates an electronic device (such as a PDA 32 or antenna 30 shown in FIG. 2), by using a Teflon body 1. The metallic signal line 2 is employed to transmit high-frequency wireless signals, or even ultra high-frequency wireless signals, through the electronic device from end to end. The signals to be transmitted through the signal line 2 would suffer an impedance of 50 ohms or 75 ohms under a frequency as high as 60 GHz. FIG. 1B is a cutaway sectional view cut along a line AA′ in FIG. 1A.

The Teflon body 1 is usually shaped in a cylinder with a central through hole, hence, no sooner has the penetration of the signal line 2 through an electronic device been made than assembling of the coupler 3 of high-frequency wireless signals of the present invention is completed. However, in addition to signal transmission between two sides of an electronic device, and for connecting those two sides together, the coupler 3 further provides an extra outer frame 4 for encaging the Teflon body 1 and meanwhile securely jointing those two opposite sides of the electronic device together through a connection part 6 to make them become a unitary body as shown in FIG. 2.

As indicated in FIG. 1C, a multi-channel high-frequency wireless signal coupler 9 may be formed by investing different metallic signal lines 2, 8 with Teflon body 7, 1 to therefore substitute for conventional male/female connectors. In order to make the technical characteristics of the coupler of the present invention clear, the way to couple the PDA 32 with the antenna 30 by means of the high-frequency wireless signal coupler 3 or by the multi-channel high-frequency wireless signal coupler 9 will be further described below.

As shown in FIG. 2, which is a schematic view of an embodiment of the present invention, the antenna 30 could be a multi-signal source and a multi-angle directivity antenna, or a smart antenna. In case the multi-channel high-frequency wireless signal coupler 9 is employed to couple the PDA 32 with the 802.11g antenna 30, since the multi-channel high-frequency wireless signal coupler 9 contains metallic signal line 2, 8, hence, it is possible to transmit high-frequency wireless signals through two or multiple channels between PDA 32 and antenna 30. Or, if the coupler 9 is substituted by the coupler 3 shown in FIG. 1A, it is also possible to transmit high-frequency wireless signals between the PDA 32 and the antenna 30.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A high-frequency wireless signal coupler, in which a plurality of metallic signal lines for connecting two opposite sides of an electronic device are invested with a Teflon body respectively; and the metallic signal lines would transmit high-frequency signals at a frequency as high as 60 GHz against an impedance of 50 ohms or 75 ohms.

2. The wireless signal coupler as claimed in claim 1, wherein the Teflon body is formed in a cylinder.

3. The wireless signal coupler as claimed in claim 1, wherein the material of the metallic signal line is copper.

4. The wireless signal coupler as claimed in claim 1 further comprising an outer frame for encaging the Teflon body, and through a connection part, two opposite sides of the electronic device being securely connected to form a unitary body.
